(19) United States
(12) Patent Application Publication
(10) Pub. No.: US 2008/0282557 A1
(43) Pub. Date: Nov. 20, 2008

(54) Handheld Power Tool

(76) Inventors: Hans Kaiser, Leuzigen (CH); Stefano Delfini, Bettlach (CH)

Correspondence Address: MICHAEL J. STRIKER, 103 EAST NECK ROAD, HUNTINGTON, NY, 11743, US

(21) Appl. No.: 12/095,041

(22) PCT Filed: Jul. 12, 2007
(86) PCT No.: PCT/EP2007/057151

§ 371 Date: May 27, 2008

(30) Foreign Application Priority Data
Sep. 4, 2006 (EP) 10 2006 041 398.9

(51) Int. Cl. B27B 19/00

(52) U.S. Cl. 30/392

(57) ABSTRACT

The invention relates to a hand machine-tool comprising a housing (12), a motor (14) which is arranged in the >housing (12) and is used to drive an inserted tool (16), and a pump unit (18) for driving a coolant flow and/or a lubricant flow (20) for cooling and/or lubricating at least one heavily loaded component (22). According to the invention, the pump unit (18) is arranged in the housing (12).

### PRIOR ART

The invention relates to a handheld power tool as generically defined by the preamble to claim 1.

From German Patent Disclosure DE 10 2004 034 814 A1, a handheld power tool is known, having a housing, a motor located in the housing for driving a tool insert, and a pump unit for driving a coolant and/or lubricant flow for cooling and/or lubricating heavily loaded components. The pump unit is located outside the handheld power tool and its housing, and an air flow that forms a means for transporting the flow of coolant and/or lubricant is delivered to the handheld power tool via a hose.

The invention is based on a handheld power tool, having a housing, a motor located in the housing for driving a tool insert, and a pump unit for driving a flow of coolant and/or lubricant for cooling and/or lubricating at least one heavily loaded component. The term “heavily loaded component” should be understood to mean in particular the tool insert and/or a unit that supports and/or guides a tool, in particular, of the handheld power tool.

It is proposed that the pump unit is located in the housing. As a result, an external pump unit and a hose for delivering the flow of coolant and/or lubricant from the pump unit to the handheld power tool can be dispensed with. Lubricating and cooling the handheld power tool or the component that needs cooling can be designed in a way that is less vulnerable to defects, and thus the mean service life of the lubricating and cooling elements of the handheld power tool can be lengthened.

The invention is usable especially advantageously in the field of hand-guided electric saws, such as jig saws, hand saws or saber saws. In principle however, its use in other devices would also be conceivable, such as power drills or sanders.

A separate motor can be dispensed with if the pump unit has a drive connection to the motor. The drive connection can be made for instance by means of a V-belt, a toothed belt, a gear, or a direct connection of a pump unit, embodied for instance as a turbine wheel, to the motor shaft or to some other shaft in the drive train of the handheld power tool.

By means of the cooling and/or lubrication according to the invention, the service life of the handheld power tool can be lengthened, particularly whenever the heavily loaded component is embodied as a saw blade guide unit for guiding a tool insert embodied as a saw blade.

By means of the cooling and/or lubrication according to the invention, the service life of the tool insert of the handheld power tool can lengthened.

Economical cooling and/or lubrication can be attained in particular with the pump unit is provided for generating an air flow. The term “provided” should be understood in this connection also to mean “designed” and “equipped”. In principle, however, it would also be conceivable to use the invention in connection with water cooling.

If the handheld power tool includes a means for mixing lubricant droplets in with the air flow, then minimal-quantity lubrication and simultaneous cooling by the air flow can advantageously be attained.

The means can be implemented structurally especially simply, and a small droplet size of the lubricant can be assured, whenever the means includes a Venturi nozzle as an essential element.

Minimal-quantity lubrication, which enables a pronounced lengthening of the service life of the loaded components with the least possible consumption of lubricant, can be attained in particular in that the Venturi nozzle is dimensioned such that less than one gram of a lubricant per hour in operation is mixed in with the air flow in operation.

By means of a lubricant container located inside the housing, the material comprising the housing itself can in particular be selected regardless of the chemical nature of the lubricant, which can for instance contain a lubricant substance containing grease and oil, or can contain graphite or the like. The separate lubricant container can furthermore be replaceable, or can be removed for refilling.

If the handheld power tool includes a refill opening for refilling the lubricant container with lubricant, then removing the lubricant container for refilling it with lubricant can be dispensed with.

Replacing an empty lubricant container with a full lubricant container is easily achieved if the lubricant container is detachably, specifically detachably in particular manually or without tools, connected to the housing.

The replacement can be done simply, particularly whenever the lubricant container is embodied as a replaceable lubricant cartridge. The lubricant cartridge can be characterized for instance by a closure opening that opens automatically upon insertion of the lubricant cartridge into a corresponding opening in the housing.

If an adjusting element for adjusting at least one parameter of the flow of coolant and/or lubricant, this parameter can be selected as a function of the current field in which the handheld power tool is used, for instance as a function of a material to be machined. The adjusting element can especially advantageously be equipped with symbols that represent the material to be machined.

The adjustable parameter is advantageously selected such that the adjusting element is provided for adjusting a quantity of lubricant transported in the flow of coolant and/or lubricant.

Further advantages will become apparent from the ensuing drawing description. In the drawings, exemplary embodiments of the invention are shown.

The drawings, description, and claims include numerous characteristics in combination. One skilled in the art will expediently consider the characteristics individually as well and put them together to make useful further combinations.

Shown are:

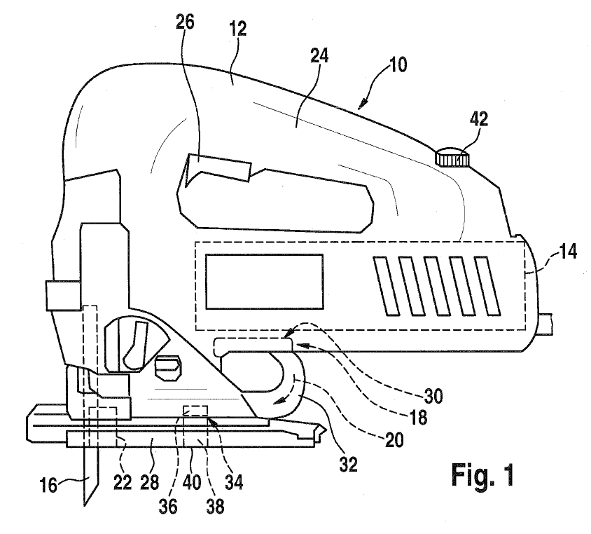

FIG. 1, a handheld power tool, with a housing and with a pump unit located in the housing, in a first exemplary embodiment of the invention; and

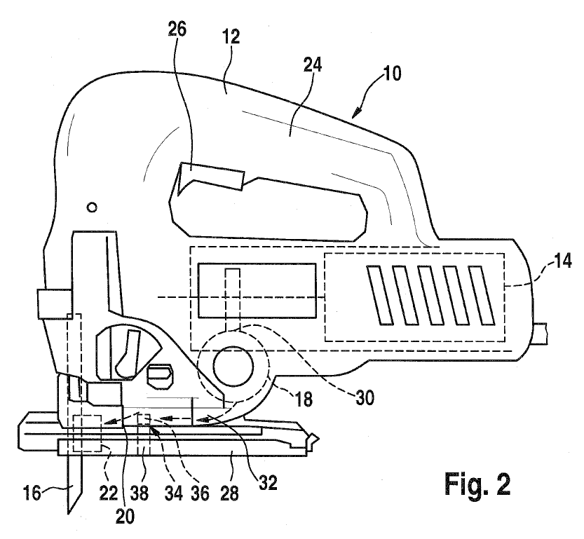

FIG. 2, a handheld power tool, with a housing and with a pump unit located in the housing, in a second exemplary embodiment of the invention.

### DESCRIPTION OF THE EXEMPLARY EMBODIMENTS

FIG. 1 shows a handheld power tool 10, embodied as a jig saw, with a housing 12, a motor 14 located on the housing 12 for driving a tool insert 16, and a pump unit 18 for driving a flow of coolant and/or lubricant 20 for cooling and/or lubricating heavily loaded components 22.

The pump unit 18 of the handheld power tool 10 is embodied as a turbine wheel and is located inside the housing 12.

The housing 12 furthermore includes a handle 24 for guiding the handheld power tool 10 and an on/off switch 26 located in the vicinity of the handle 24. Besides the housing 12, the handheld power tool 10 includes a base plate 28 for guiding the handheld power tool 10 on a surface of a workpiece (not shown here); the base plate 28 preferably comprises diecast material.

The pump unit 18 is connected via toothed gearing to a driveshaft of the motor 14, so that it has a drive connection 30 with the motor 14 embodied as an electric motor. The drive connection 30 is designed such that whenever the motor 14 is being operated, the pump unit 18 is necessarily being operated as well.

One of the heavily loaded components 22 of the handheld power tool 10 that are cooled and lubricated by the flow of coolant and/or lubricant 20 is embodied as a saw blade guide unit. In operation, the saw blade guide unit guides a tool insert 16, embodied as a saw blade, in pendulum fashion up and down in a manner known per se.

The pump unit 18 is provided for generating an air flow, specifically in such a way that it aspirates air from outside through a filter or a grid and introduces it at high pressure into a cooling air line 32.

The cooling air line 32 extends partially outside the housing 12 and opens into the base plate 28, to which it extends parallel, in an end region.

The cooling air line 32 carries the air flow through a means 34 for mixing lubricant droplets in with the air flow. The means 34 includes a Venturi nozzle 36, shown here only schematically, as its central element.

The Venturi nozzle 36 is dimensioned such that in operation, less than one gram of a lubricant per hour of operation is mixed in with the air flow, so that during continuous operation of the handheld power tool 10 over a full day, only approximately a thimbleful of lubricant is entrained by the cooling air flow and carried to the heavily loaded components 22 that are to be cooled. There, the lubricant, carried in the form of small droplets in the cooling air flow, is also deposited on the surface of the heavily loaded components 22 that are to be lubricated, or on the surface of the tool insert 16, and leads to minimal-quantity lubrication, which markedly increases the service life of the components 22 or the tool insert 16.

At the same time, the predominant amount of the air in the coolant and/or lubricant flow 20 that comprises air and lubricant, assures cooling of the applicable components 22 or tool insert 16. As a result, the wear, particularly of the tool insert 16, is lessened, and the service life of the entire handheld power tool 10 or of the applicable components 22 is increased still further.

The lubricant is delivered to the flow of coolant and/or lubricant 20 via the Venturi nozzle 36 from a lubricant container 38, which is located inside the housing 12 and which in an exemplary embodiment shown here only in dashed lines includes a refill opening 40 for refilling lubricant in the lubricant container 38.

In the exemplary embodiment shown in FIG. 1, the lubricant container 38 is detachably connected to the housing 12 and is furthermore embodied as a replaceable lubricant cartridge. The design of the lubricant cartridge, which includes a plastic sleeve and a closing ball, can for instance be similar to the design of known ink cartridges for fountain pens.

FIG. 2 shows an alternative exemplary embodiment of the invention, in which, in the vicinity of a handle 24 of the housing 12 of the handheld power tool 10, an adjusting element 42 (FIG. 1) is provided for adjusting at least one parameter of the flow of coolant and/or lubricant 20, specifically an intensity of the minimal-quantity lubrication created by the lubricant.

In the exemplary embodiment of FIG. 2, the pump unit 18 is equipped with a turbine wheel, which is rotatable about a horizontal axis of rotation that extends perpendicular to the longitudinal direction of the tool insert 16.

Via the adjusting element 42 (FIG. 1), a cross section of a constriction of the Venturi nozzle 36 can be varied. As a result, an underpressure at an orifice of the lubricant container 38, which is determined by the pressure in the constriction of the Venturi nozzle 36, varies. As a result of the variation in the underpressure, the quantity of lubricant transported from the lubricant container 38 and in the flow of coolant and/or lubricant 20 varies.

1. A handheld power tool, having a housing (12), a motor (14) located in the housing (12) for driving a tool insert (16), and a pump unit (18) for driving a flow of coolant and/or lubricant (20) for cooling and/or lubricating at least one heavily loaded component (22), characterized in that the pump unit (18) is located in the housing (12).

2. The handheld power tool as defined by claim 1, characterized in that the pump unit (18) has a drive connection (30) to the motor (14).

3. The handheld power tool as defined by claim 1, characterized in that the heavily loaded component (22) is embodied as a saw blade guide unit for guiding a tool insert (16) embodied as a saw blade.

4. The handheld power tool as defined by claim 1, characterized in that the heavily loaded component (22) is embodied as a tool insert (16).

5. The handheld power tool as defined by claim 1, characterized in that the pump unit (18) is provided for generating an air flow.

6. The handheld power tool as defined by claim 5, characterized by a means (34) for mixing lubricant droplets in with the air flow.

7. The handheld power tool as defined by claim 6, characterized in that the means (34) includes a Venturi nozzle (36).

8. The handheld power tool as defined by claim 7, characterized in that the Venturi nozzle (36) is dimensioned such that less than one gram of a lubricant per hour in operation is mixed in with the air flow in operation.

9. The handheld power tool as defined by claim 1, characterized by a lubricant container (38) located inside the housing (12).

10. The handheld power tool as defined by claim 9, characterized by a refill opening (40) for refilling the lubricant container (38) with lubricant.

11. The handheld power tool as defined by claim 1, characterized in that the lubricant container (38) is detachably connected to the housing (12).

12. The handheld power tool as defined by claim 11, characterized in that the lubricant container (38) is embodied as a replaceable lubricant cartridge.

13. The handheld power tool as defined by claim 1, characterized by an adjusting element (42) for adjusting at least one parameter of the flow of coolant and/or lubricant (20).

14. The handheld power tool as defined by claim 13, characterized in that the adjusting element (42) is provided for adjusting a quantity of lubricant transported in the flow of coolant and/or lubricant (20).
